(19) United States
(12) Patent Application Publication
(10) Pub. No.: US 2002/0020588 A1
(43) Pub. Date: Feb. 21, 2002

(54) Bicycle brake micro-spring adjuster

(76) Inventor: Robert Valdez, Lake Forest, CA (US)

Correspondence Address: Charles H. Thomas, CISLO & THOMAS LLP, Suite 405, 4201 Long Beach Blvd., Long Beach, CA, 90807-2022, US

(21) Appl. No.: 09/892,054

(22) Filed: Jun. 26, 2001

Related U.S. Application Data
(60) Provisional application No. 60/214,001, filed on Jun. 26, 2000.

(51) Int. Cl. B62L 3/00

(52) U.S. Cl. 188/24.21; 188/24.11

(57) ABSTRACT

A micro-spring brake adjuster is provided for a bicycle brake having a pair of bicycle brake lever arms mounted rotatably on the bicycle frame fork arms of a bicycle. Bicycle brakes of this type utilize elongated, linear spring rods that are resiliently deflected to apply biasing forces that tend to disengage the brake pads from contact with the bicycle wheel rim. The brake adjuster includes a body that fits onto a bicycle brake spring rod. The brake adjuster is also provided with structure having a cam surface that can be interposed between the brake spring rod and the spring pin against which the brake spring rod resiliently bears. Longitudinal movement of the adjuster along the length of the spring rod in one direction increases the amount of structure of the adjuster interposed between the spring rod and the spring pin, thereby increasing the resilient deflection of the linear spring rod, which in turn increases the outwardly biasing force that the spring rod exerts on the brake pad. Conversely, longitudinal movement of the adjuster in the opposite direction along the spring rod reduces the amount of structure of the adjuster interposed between the spring rod and the spring pin against which the spring bears. This reduces the spring bias against the spring pin, thereby reducing the force with which the brake pad is biased away from the bicycle wheel rim. The micro-spring adjuster of the invention can be operated without dismounting from the bicycle and can fine tune the bias of each brake spring rod independently of the other in a bicycle brake assembly.

The present application claims the benefit of priority of prior Provisional Patent Application Serial No. 60/214,001 filed Jun. 26, 2000, presently pending.

### BACKGROUND OF THE INVENTION

1. Field of the Invention

The present invention relates to an improved bicycle brake adjustment mechanism for adjusting brake spring tension and which may be installed and adjusted without tools on a wide variety of BMX and mountain bike brakes.

2. Description of the Prior Art

In conventional BMX and mountain bikes, both the front and rear bicycle wheel forks are formed with arms of tubular steel. Caliper and/or cantilever brakes are mounted upon both arms of at least the rear bicycle wheel fork. The standard bicycle brake mounting apparatus for both BMX and mountain bikes is comprised of a brake mounting base on each fork arm. The brake mounting base is formed as a short, steel pedestal having a generally circular cross section secured to each fork arm and projecting in a direction parallel to the plane of the bicycle wheel that is located between the fork arms. The bicycle mounting bases are welded to the steel fork arms.

Each of the brake mounting bases is provided with a brake axle that projects outwardly from the brake mounting base, also in a direction parallel to the plane of the bicycle wheel located between the fork arms. The brake axles have an outside diameter smaller than that of the brake mounting bases from which they project. The brake lever arms that carry the brake pads are mounted for rotation on the brake axles.

The brake lever arms each have a mounting end journaled on the brake axle and an opposite, distal end. Each brake lever arm carries a brake pad on its distal end at some distance from the axis of rotation of the brake lever arm about the brake axle. Each of the brake lever arms also has a spring in the form of a relatively long, linear, slender steel rod, typically about four inches in length and about one-sixteenth of an inch in diameter. One mounted end of each brake spring rod is anchored or clamped relative to the bicycle frame at the bicycle brake mounting base, while the other free end of the brake spring rod extends outwardly in cantilevered fashion alongside the brake arm. Near its extremity, the free end of each brake spring rod bears laterally against a bearing post, also called a spring pin. The spring pin also projects outwardly from the brake lever arm in a plane parallel to the plane of the bicycle wheel. The brake lever springs thereby bias the distal ends of the brake lever arms apart, thereby forcing the brake pads away from the bicycle wheel rim.

When tension is exerted on the brake cable, the distal ends of the brake lever arms are forced inwardly toward each other against the bias of the brake spring rods, thereby forcing the brake pads toward opposing sides of the wheel rim and bringing them into contact with the wheel rim. Friction between the brake pads and the wheel rim slows or stops the rotation of the bicycle wheel.

During the mountain bike racing and endurance events bicycle riders often find it necessary to make small but very important adjustments to the spring tension of their bicycle brakes. However, in conventional bicycle brakes all such adjustments require the use of some tool or another, such as a wrench or screwdriver. Also, in order to make even a very small adjustment, a rider must dismount from the bicycle, employ the tool as necessary, and then remount the bicycle and continue onward. Thus, in order to perform any adjustment at all in a conventional bicycle brake system a significant loss of time is involved.

Furthermore, some conventional bicycle brake systems are constructed in such a manner that very fine adjustments in brake tension cannot be made. Rather, adjustments can be performed only in predetermined increments which may be excessively large. Therefore, a rider is prevented from fine tuning the spring brake bias just the right amount.

Typical situations in which fine tuning of brake adjustment is extremely important are short (½ to 1 mile) BMX track races and mountain biker downhill races (¼ mile and cross country miles). Both of these types of events involved riding on rough and diverse terrain and at speeds that vary considerably. Road bikers typically travel on flat terrain with varying speeds. In all such competitive events there is a recognition of the need to make independent fine tuning adjustments to the spring tension on each of the brake lever arms of each brake assembly of the bicycle. However, in a race or other competitive event there is inadequate time to perform the necessary adjustment to conventional brake spring systems. A rider is put at a disadvantage if forced to enter or continue a race with unbalanced spring tension. Even a slight imbalance or inequality in brake pad force toward opposite sides of the rim of the tire will be felt by the rider and detract from the rider's efficiency of performance. This reduces the rider's overall competitiveness and also results in a loss of confidence.

### SUMMARY OF THE INVENTION

The present invention provides a micro-spring adjusting device that can be attached to the vast majority of bicycle brake biasing springs that are utilized commercially today, particularly those used on BMX and mountain bikes. Furthermore, the adjustment device of the invention can be easily attached to the bicycle spring without any tools at all. It can also be adjusted without the use of any tools. Moreover, adjustments can be performed by the rider without dismounting the bicycle. Adjustments can also be made to vary the bias on each brake lever arm in a brake assembly independently of the other.

In one broad aspect the invention may be considered to be a detachable adjustment mechanism for a bicycle brake comprising a body having an opening defined therethrough which snugly receives a bicycle brake spring rod that extends through the adjustment mechanism body. The diameter or other cross section of the opening is such that the body will remain in a selected position along the length of the linear brake spring rod unless purposefully pushed toward the free cantilevered extremity to increase the bias on the spring or toward the anchored end of the linear brake spring rod to decrease the bias on the spring. The size of the opening is such that the body will remain frictionally engaged at a selected position along the length of the spring rod as determined by the rider. The adjustment mechanism also includes a portion having a cam surface defined thereon.

The cam portion of the adjustment mechanism is located between the bearing or spring pin projecting from the brake arm and the linear brake spring rod. The width of the structure of the cam portion that is interposed between the bearing pin and the brake spring rod determines the extent to which the cantilevered tip of the brake spring rod is angularly deflected from the position it would otherwise occupy if the brake spring rod were to bear directly against the bearing pin of the brake lever arm. The further the brake spring is deflected away from the bearing pin by the adjustment device, the greater will be the biasing force exerted by the spring tending to press the brake pad away from the bicycle wheel tire rim. Movement of the adjustment device longitudinally along the length of the brake spring rod alters this force.

In another broad aspect the invention may be considered to be a bicycle brake spring tension adapter for a linear wire bicycle brake spring rod comprising a unitary device shorter in length than the spring rod and having opposing proximal and distal ends and a bridging portion extending therebetween. A proximal end opening is defined in the proximal end for receiving the wire spring rod therewithin in frictional engagement therewith. A distal end opening is defined in the distal end, also for receiving the wire spring rod therewithin in frictional engagement therewith. At least one cam surface is defined on the device between the proximal and distal ends thereof.

In still another aspect the invention may be considered to be a spring tension adjustment device for a linear wire or bicycle brake spring rod having an anchored end and an opposite distal end. The device is comprised of a structure shorter than the spring rod. The structure includes a body formed with an opening therethrough for receiving the wire spring rod therewithin, a bridging portion extending from the body in the direction of the distal end of the wire spring rod, and a foot at the end of the bridging portion opposite the body. The foot has an opening therethrough defined about a longitudinal axis. The opening receives the wire spring rod therewithin. At least one cam surface is defined on the structure at an inclination relative to the longitudinal axis of the opening in the foot. The transverse distance between locations on the cam surface and the longitudinal axis of the opening in the foot varies with longitudinal distance from the distal end of the wire spring rod.

The invention may also be considered to be an improvement in a bicycle brake employing a spring rod engaging pin and a linear bicycle brake spring rod. The spring rod has an anchored end and an opposite distal end. The spring rod is resiliently deflected so that the distal end of thereof engages the spring rod engaging pin. The improvement of the invention is a spring adjuster having at least one opening defined therethrough to receive the spring rod therewithin. The spring adjuster has a cam portion that defines at least one cam surface thereon. The cam portion is movable to a selected extent into interposition between the spring pin and the distal end of the spring rod to thereby vary preloaded tension on the spring rod

The spring tension adjustment device is preferably formed as a plastic part having a longitudinally oriented opening defined therethrough to receive the brake spring rod. The length of the adjustment device may vary. It must, of course, be shorter than the brake spring rod. Preferably, the adjustment device is between about one inch and two inches in length. The greater the length of the adjustment device the more gradual the incline of the cam surface can be relative to the axis of the opening that is defined therethrough. The more gradual the cam surface incline, the greater will be the precision in fine tuning the spring bias.

One disadvantage of a relatively long adjustment device formed as a solid piece, however, is that the bowing or arching of the brake spring rod when the brake spring rod is placed under tension will tend to cause the adjustment device to bind on the rod. This can be corrected by increasing the diameter or other cross-sectional area of the rod-receiving opening in the adjustment device. However, there is sometimes simply not enough structure in the device to allow any significant increase in diameter of the opening because of the very small size of the adjustment device.

To solve this problem the adjustment device is preferably constructed with a relatively large body portion with a narrow bridging portion extending therefrom. The bridging portion has an enlarged foot at its distal extremity remote from the body portion. Openings are defined through both the body portion and the foot at the distal end of the bridging portion. The central span of the bridging portion arches over the brake spring rod so that the brake spring rod makes contact with the adjustment device only within the body portion and within the foot at the distal end of the bridging portion. A cam surface is formed on the surface of the bridging portion opposite the surface of the bridging portion that faces the brake spring rod. The cam surface can be a smooth incline. However, the cam surface can alternatively be provided with a series of raised, transverse ribs or ridges that define a series of detent positions along the length of the adjustment device. The detent positions prevent undesired sliding or shifting of the point of contact between the bearing pin and the cam surface.

The invention may be described with greater clarity and particularity by reference to the accompanying drawings.

### DESCRIPTION OF THE DRAWINGS

FIG. 1 is a rear elevational view of one conventional commercially popular bicycle brake mechanism with which the micro-spring adjuster of the invention can be utilized.

FIG. 2 is a side elevational view taken along the lines 2-2 of FIG. 1.

FIG. 2A is a side elevational view showing a modified version of the brake shown in FIG. 2.

FIG. 3 is a front elevational view of the bicycle brake of FIG. 1.

FIG. 4 is a side elevational view taken along the lines 4-4 of FIG. 3.

FIG. 5 is a front elevational view of the bicycle brake shown in FIG. 3 employing one embodiment of the micro-spring brake adjuster of the invention.

FIG. 6 is a side elevational view taken along the lines 6-6 of FIG. 5.

FIG. 7 is a detail view illustrating a single one of the bicycle brake arms and a single one of the spring brake rods of the bicycle brake shown in FIG. 5.

FIG. 8 is a detail view illustrating one embodiment of a micro-spring adjuster according to the invention mounted on the spring brake rod of the bicycle brake arm shown in FIG. 7, but disengaged from a biasing position.

FIG. 9 illustrates the micro-spring adjuster shown in FIG. 8 engaged to provide a maximum bias to the brake spring rod.

FIG. 10 illustrates an alternative embodiment of a single brake lever arm and spring brake rod to that shown in FIG. 7 in one position of adjustment.

FIG. 11 illustrates the brake lever arm of FIG. 10 in an alternative position of adjustment.

FIG. 12 illustrates the brake lever arm of FIGS. 10 and 11 with one embodiment of the micro-spring adjuster of the invention mounted thereon.

FIG. 13 is an enlarged side elevational view showing the micro-spring adjuster employed in FIGS. 5, 6, 8, 9 and 12 in isolation.

FIG. 14 is a bottom plan view taken along the lines 14-14 in FIG. 13.

FIG. 15 is an enlarged side elevational view of an alternative embodiment of a micro-spring adjuster to that shown in FIG. 13.

FIG. 16 is a bottom plan view taken along the lines 16-16 of FIG. 15.

FIG. 17 is a side elevational detail taken along the lines 17-17 of FIG. 15.

FIG. 17A is a side elevational detail showing the end of the body illustrated in FIG. 17 when removed from the bicycle brake spring rod.

FIG. 18 is an enlarged side elevational view showing another alternative embodiment of a micro-spring adjuster of the invention to those shown in FIGS. 13 and 15.

FIG. 19 is an enlarged side elevational view showing still another alternative embodiment of a micro-spring adjuster of the invention to those shown in FIGS. 13, 15 and 18.

FIG. 20 is a rear elevational view illustrating another alternative embodiment of a bicycle brake to that shown in FIG. 3 with which the micro-spring adjuster of the invention can be utilized.

FIG. 21 is a side elevational view taken along the lines 21-21 of FIG. 20.

FIG. 22 is an elevational detail taken along the lines 22-22 of FIG. 21 illustrating a portion of the bicycle frame to which the bicycle brake of FIGS. 20 and 21 is mounted.

### DESCRIPTION OF THE EMBODIMENT

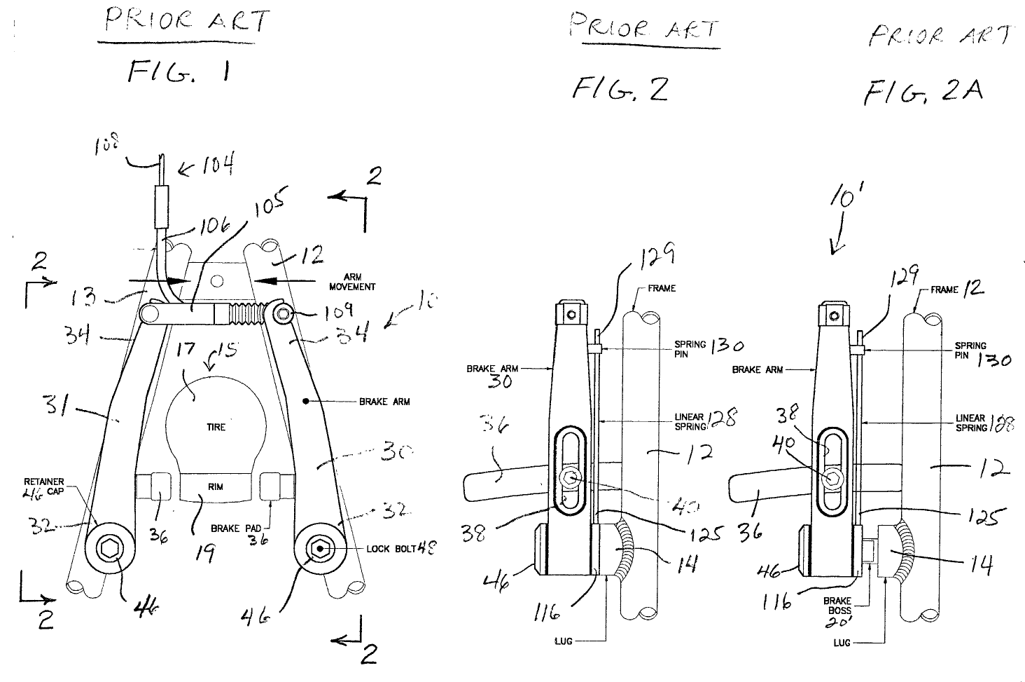

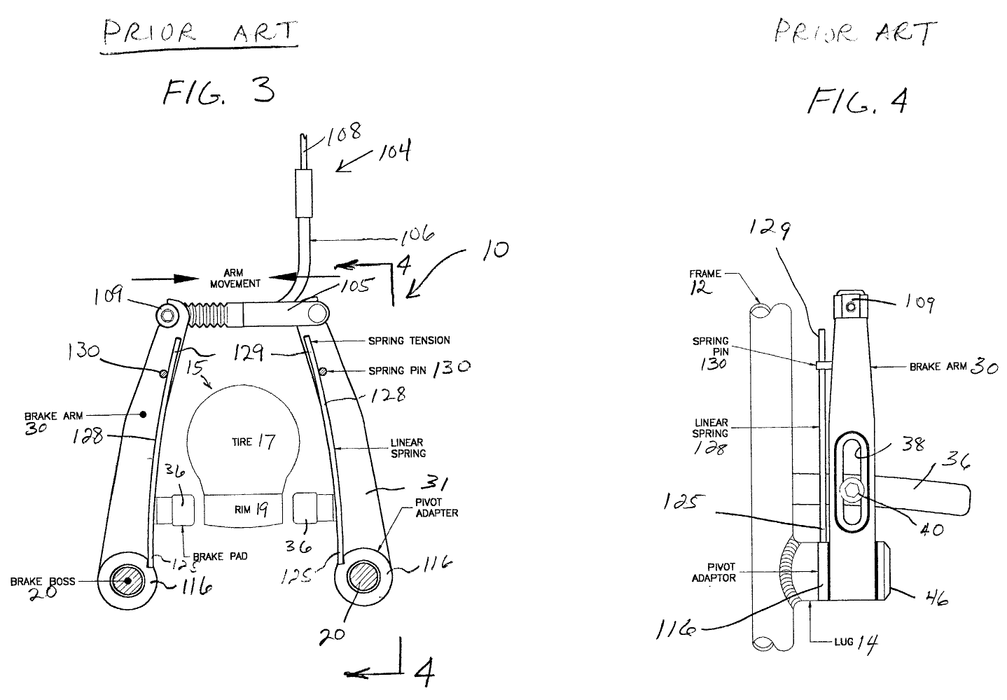

FIGS. 1, 2, 3, and 4 illustrate a typical type of braking mechanism for BMX mountain bikes. This type of brake is commonly known as a cantilever brake, a linear brake, a “V”-type brake, or a side pull brake. The brake assembly is indicated generally at 10. This particular brake assembly is described more fully in U.S. patent application Ser. No. 09/080,036 filed May 15, 1998, presently pending, and is sold by Bear Corp. located in Cerritos, Calif. under the brand name A-BRAKE. The bicycle brake mechanism 10 is mounted on the fork arms 12 and 13 of the bicycle fork within which a bicycle wheel 15 rotates. The bicycle wheel 15 includes a pneumatic tire 17 mounted on a metal rim 19. As illustrated in FIGS. 1 and 3, the bicycle wheel 15, shown in phantom, is located within the confines of the pair of bicycle fork arms 12 and 13.

A short, generally cylindrical bicycle brake mounting base or lug 14 is welded to the inside surface of each of the fork arms 12 and 13 to project outwardly therefrom. A central, internally tapped axle mounting bore is defined in the structure of each of the brake mounting bases 14 and extends inwardly generally toward the fork arms 12 and 13. The brake mechanism 10 employs a pair of detachable and replaceable brake axles 20, known in the trade as brake bosses. Each brake boss has a distal, outer brake lever receiving end remote from the brake mounting base 14 with an internally tapped bore defined therewithin. The opposite, proximal end of the brake boss 20 is a stud which is externally threaded with male threads that are engaged in the internally tapped mounting bore of the brake mounting base 14.

The brake assembly 10 employs a pair of brake lever arms 30. and 31 each having a mounting end 32 and an opposite distal, cantilevered end 34. The brake lever arms 30 and 31 are of mirror image construction. A brake pad 36 is secured to the cantilevered end 34 of each of the brake lever arms 30 and 31 at a selected position along an elongated brake clamping slot 38 by means of a clamping screw 40. The position of the brake pad 36 both in orientation relative to the clamping slot 38 and in distance from the axis of rotation of the brake lever arms 30 and 31 at their mounting ends 32 is adjustable by loosening and tightening the clamping screw 40.

A smooth, cylindrical opening is defined through the proximal mounting end 32 of each brake lever arm 30 and 31. A cylindrical, annular Teflon® bearing surrounds the distal portion of each brake boss 20 throughout most of its length to provide a journaled connection between the proximal mounting ends 32 of the brake lever arms 30 and 31 and the brake bosses 20. The brake lever arms 30 and 31 are secured in position for rotation about the distal ends of the brake bosses 20 by means of annular retaining caps 46 and lock bolts 48.

The brake pads 36 are brought to bear against the rim 19 of the bicycle wheel 15 by means of a hand actuated brake tensioning cable 104. The cable 104 has an outer sheath 106 and an inner core 108. The cable sheath 106 of the cable 104 is secured to a cable bracket 105 that is anchored to the distal end 34 of the brake lever arm 31. The central wire core 108 of the cable 104 is rigidly secured to a cable termination lug 109 mounted on the distal end of brake lever arm 30. When tension is exerted on the central cable core 108 of the cable 104 within the sheath 106, the distal ends 34 of the brake lever arms 30 and 31 are drawn in toward each other, thereby bringing the brake pads 36 to bear against the rim 19 of the bicycle wheel 15. The braking action of the brake mechanism assembly 10 is conventional.

There are brake spring mounting sleeves which have tubular portions (not visible) located coaxially within the Teflon® bearings within each mounting end 32 of each brake lever arm 30 and 31. These tubular portions project through the openings in the proximal ends 32 of the brake lever arms 30 and 31. Each sleeve also has an annular spring mounting flange 116 at the end of its tubular portion adjacent the brake mounting base 14. The flange 116 is visible in the drawings. Each flange 116 defines a spring socket that receives a fixed or mounted end 125 of a linear spring rod 128. The mounted end 125 of the linear spring 128 is bonded or staked in place in the spring socket in each flange 116. The other, cantilevered free end 129 of each brake spring rod 128 bears against a spring bearing post or pin 130 that projects from the distal end 34 of each of the brake lever arms 30 and 31.

The spring mounting flange 116 may be secured or anchored relative to the brake mounting base 14 in a variety of ways. In the brake assembly 10 the lock bolt 48 locks the sleeve bearing the spring mounting flange 116 into place once the spring 128 is in the desired position of alignment relative to the brake lever arm 130 or 131 to which it is to provide a bias. FIG. 2A illustrates another cantilever brake 10′ of alternative design in which the spring mounting flange 116 is seated against flats on a shoulder on the brake boss 20′, whereby it is immobilized from rotation relative to the bicycle frame.

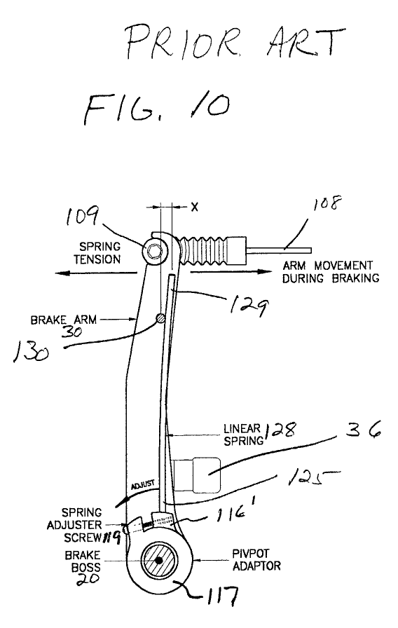

FIGS. 10 and 11 illustrate still another alternative spring mounting system wherein the spring 128 is fixed on the spring adapter flange 116′ and a separate, collar 117 carries a spring adjuster screw 119, the threaded shank of which is threadably engaged with the spring adapter flange 116′. The collar 117 is anchored to the brake mounting base 14. Tightening and untightening of spring adjuster screw 119 alternatively loosens or increases tension on the spring 128 when the angular displacement between the spring adapter flange 116′ and the rotatable collar 117 is adjusted. When the angular displacement between the rotatable collar 117 and the adapter flange 116′ is increased, as illustrated in FIG. 10, the tension on the spring 128, and hence the force pulling the brake pad 36 away from the bicycle wheel is reduced. In contrast, when the spring adjuster screw 119 is tightened as shown in FIG. 11, tension on the spring 128 is increased, thereby increasing the force with which the brake pad 36 is pulled away from the bicycle wheel 15.

In any event, the spring mounting flange 116 or the adapter flange 116′ is secured relative to the bicycle frame and cannot rotate relative to the bicycle fork legs 12 and 13 during operation of the bicycle. The linear brake springs 128 are resiliently deflected from their normal linear alignment so that they exert outward forces against the spring pins 130 and away from the bicycle wheel 15. This outward bias exerted by the linear brake spring rods 128 pushes the distal ends 34 of both of the brake lever arms 30 and 31 away from each other thereby pulling the brake pads 36 away from the tire rim 19 in the absence of a braking force exerted by means of the brake cable 104.

When tension is exerted on the cable core wire 108 of the brake cable 104, however, the outwardly biasing forces provided by the distal ends 129 of the linear brake spring rods 128 are overcome, and the distal ends 34 of the brake lever arms 30 and 31 are drawn toward each other. This presses the brake pads 36 against the tire rim 19, thereby providing a braking force to the bicycle wheel 15.

Spring and brake systems of the type employed in the brake assembly 10 are preferred due to the independent spring adjustments which can be made. That is, since each of the lever arms 30 and 31 is separate from the other, the tension on the spring 128 for each lever arm 30 and 31 can be adjusted independently. Prior bicycle brake assemblies employed a single adjustment mechanism for dual springs or a single spring with no adjustment mechanism.

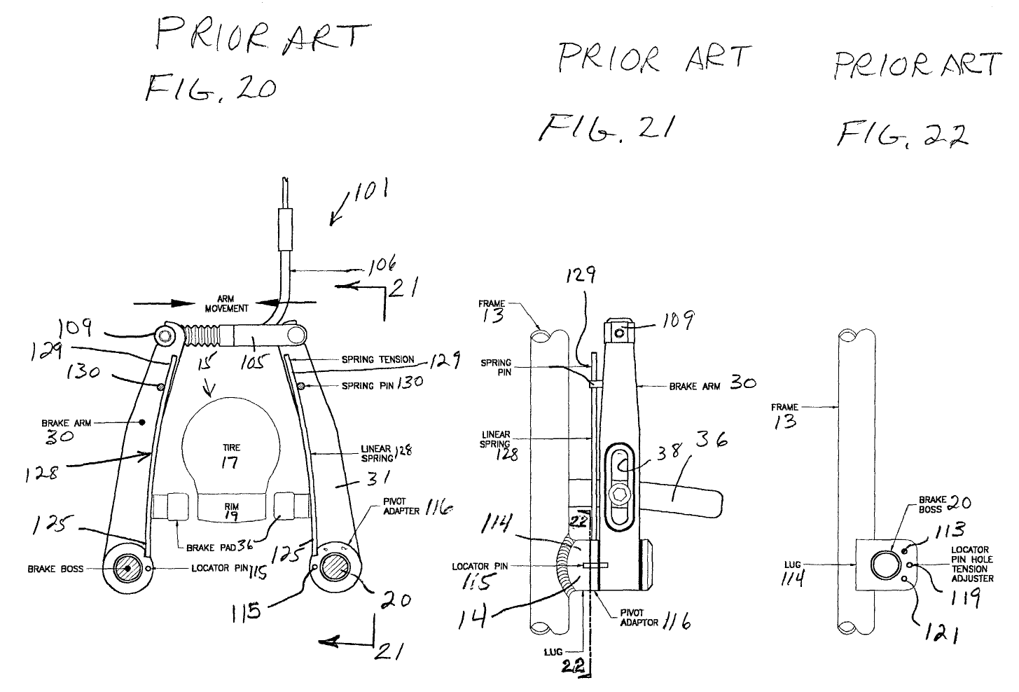

Another type of conventional brake mechanism has fixed spring adjustments that in actuality can never be equal due to variations of the parts involved resulting from manufacturing deviations and variations of the spring pins and pin holes on the frame. This results in unequal brake pad tension and prevents the brake pads from contacting the rim simultaneously. Braking force and brake responsiveness are thereby hampered. A brake system of 101 of this type is illustrated in FIGS. 20, 21, and 22. As illustrated in those drawing figures, the spring mounting flange 116 is immobilized relative to the brake mounting base 114 by means of a locator pin 115 that projects from the spring mounting flange 116 parallel to the brake boss 20. The locator pin 115 fits into a selected locator pin hole 113, 119, or 121. Depending upon the hole 113, 119, or 121 with which the locator pin 115 is engaged, tension on the spring 128 will be increased or decreased.

All of the prior art brake systems illustrated have inadequate adjustment systems. Some of them simply do not allow enough tension on the springs 128 to be created. All of these prior systems require tools to perform the adjustments that are available. Moreover, a bicycle rider must be dismounted from the bicycle in order to perform any adjustment.

FIGS. 13 and 14 illustrate one preferred embodiment of a micro-spring brake adjusting device 200 according to the present invention. The spring adjuster 200 may be fabricated as a small elongated plastic structure having a length about 1.75 inches. The brake spring adjuster 200 has a body 202 which may be considered to be located at the proximal end of the spring adjuster 200. The body 202 is relatively massive and has a spring hole or opening 204 defined therethrough in a longitudinal direction. The whole or opening 204 defines a proximal end longitudinal axis of spring rod alignment 205. The adjusting device 200 also has a bridging portion 206 that extends longitudinally in a distal direction from the body 202 and terminates in a slightly enlarged foot 208. The foot 208 may be considered to be the distal end of the spring adjuster 200. Like the body portion 202, the foot 208 has a longitudinal hole or opening 210 defined therethrough. The opening 210 through the foot 208 defines a distal end longitudinal axis of spring rod alignment 211.

The bridging portion 206 may be about three-quarters of an inch in length and has a concave groove defined in its under surface. This groove is indicated at 212. The exposed, outer contact surface of the bridging portion 206 has a general incline at a cam angle that may vary from between about five degrees and about thirty degrees. The nose of the foot 208 of the brake spring adjuster 200 has a cam surface 214. The cam surface 214 is smooth and flat. The cam surface 214 of the foot 208 of the brake spring adjuster 200 may be considered to be a first cam surface and is indicated as Cam Angle No. 1. The angle of inclination of the cam surface 214 is linear relative to the longitudinal axis of distal end alignment 211 and may vary from between about thirty degrees and about sixty degrees. Cam Angle No. 1 is preferably about forty-five degrees.

The inclination of the exposed, outer, contact cam surface 220 of the bridging portion 206 is indicated by Cam Angle No. 2, and is preferably between about five degrees and about twenty degrees relative to the axis 211. The cam surface 220 may be considered to be a second cam surface and also resides at a linear angle of inclination relative to the distal end longitudinal axis of alignment 211. Cam Angle No. 1 of the foot 208 is steeper than the Cam Angle No. 2 of the bridging portion 206, considered relative to the distal end axis of alignment 211 . Cam Angle No. 2 is preferably about thirteen degrees. Unlike cam surface 214, cam surface 220 has a plurality of transverse, raised ribs 222 spaced along its length. The ribs 222 define therebetween concave detent recesses or depressions 223 which have an arcuate curvature that matches the curvature of the spring rod engaging pin 130.

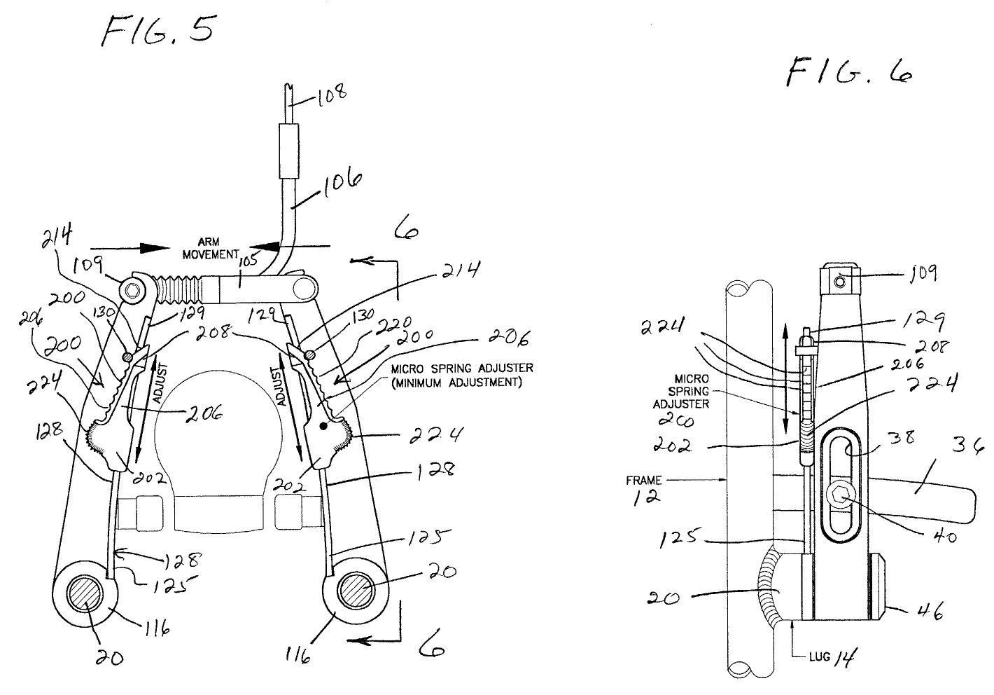

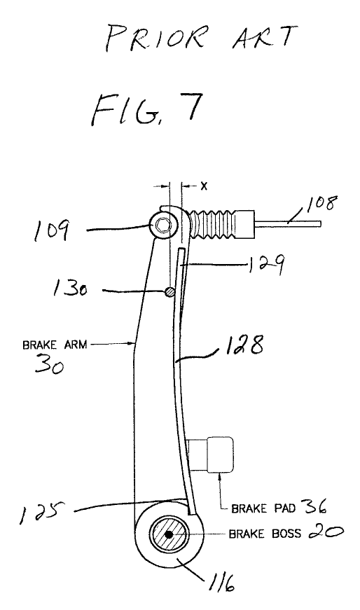

At the end of the bridging portion 206 remote from foot 208 the outer surface of the body 202 is configured with tooth-like ridges 224 that facilitate engagement by a user's fingertips or fingernails. The outwardly projecting protrusions formed by the projections 224 on the proximal end of the spring adjuster 200 facilitate engagement of the spring adjuster 200 by a user's fingertips. The bicyclist exerts manual pressure to push upon the adjuster 200 at the projections 224 in a longitudinal direction parallel to the axis of alignment 211 of the bores 202 and 210 to adjust spring tension. The operation of the adjuster 200 may be described with reference to drawing FIGS. 5 through 8.

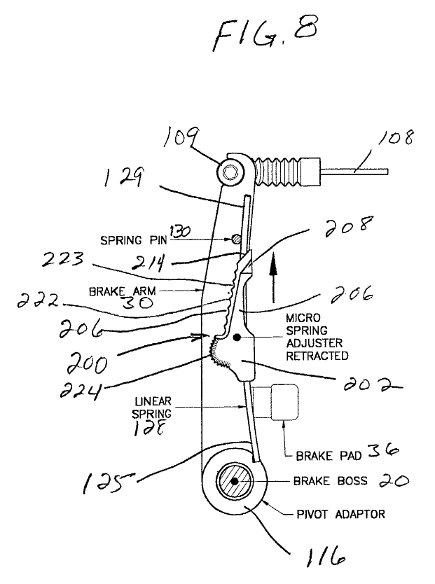

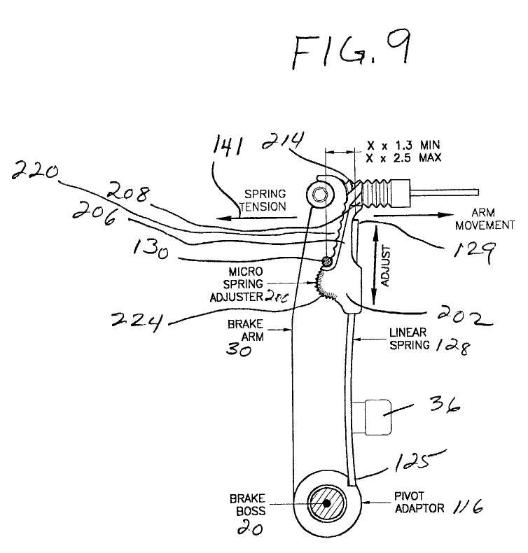

FIG. 7 illustrates in isolation the bicycle brake lever arm 30 and the linear spring rod 128 thereon that is shown in the bicycle brake system depicted in FIG. 3. A brake spring adjuster 200 is mounted upon the linear spring rod 128 by first disengaging the spring 128 from contact with the spring rod engaging pin 130. The tip of the free end 129 of the spring rod 128 is inserted first into the bore 204 of the adapter base 202, along the groove 212 in the bridge portion 206 and into the bore 210 of the foot 208. The adapter 200 is then pushed longitudinally down the spring rod 128 toward the proximal mounted end thereof to the extent desired. If no increase in spring tension is desired at the moment, the adjuster 200 is pushed down the length of the spring rod 128 to the position shown in FIG. 8. The distal end 129 of the spring rod 128 is then flexed and reengaged behind the spring pin 130 as shown in FIG. 8.

Because the free end 129 of the spring rod 128 is deflected from linear alignment with the mounted end 125 thereof to engage the spring rod engaging pin 130, a slight flexing or bowing of the spring rod 128 occurs. In the spring adjuster 200 the distal end longitudinal axis of spring rod alignment 211 and the proximal end longitudinal axis of spring rod alignment 205 are mutually coaxial when the bridging portion 206 resides in an undeflected condition. Due to its relatively long length, the bridging portion 206 of the plastic spring adjuster 200 has a certain limited degree of resilient flexibility. By flexing or bowing the spring 128 a slight misalignment is created between the longitudinal axes 205 and 211 of the bores 204 and 210, respectively, in the adapter 200. This slight misalignment helps provide some frictional engagement between the adapter 200 and the spring rod 128. This is desirable since such frictional engagement aids in preventing an undesired or an unintended longitudinal movement of the adapter 200 along the length of the spring rod 128.

If the bicycle rider wishes to increase the spring tension exerted on the brake pad 36 by the spring rod 128, the rider presses the body 202 of the adjuster 200 at the push tabs 224 toward the distal end 129 of the spring rod 128, as illustrated in FIG. 5. The cam surface 214 at the foot 208 of the adjuster 200 makes contact with the spring pin 130 and increases the resilient deflection of the spring rod 128 slightly, as illustrated in FIG. 5. The adjuster 200 is preferably pushed far enough toward the distal end 129 of the spring rod 128 so that the cam surface 214 is forced past the spring pin 130. The spring rod engaging pin 130 then seats in the first detent recess 224 on the bridge portion 206 adjacent the adjuster foot 208. The transverse distance between locations at the detent recesses 224 on the cam surface 220 increases with longitudinal distance from the foot 208 at the distal end of the spring adjuster 200 and with longitudinal distance from the distal end 129 of the spring rod 128. Once the cam surface 220 of the bridge portion 206 engages the spring pin 130 in a detent recess 224, the angular force of the spring rod 128 outwardly toward the spring pin 130 will hold the adjuster 200 in position and prevent it from moving longitudinally along the length of the spring rod 128 unless purposely moved by the rider. The cam surface 220 thereby varies adjustment of the preload on the spring rod 128 in discrete increments To achieve even greater brake spring tension the rider pushes the micro-spring adjuster 200 longitudinally onward out toward the tip of the free end 129 of the spring rod 128 to increase the width of the portion of the structure of the adjuster 200 that is interposed between the spring rod 128 and the spring pin 130. The adjuster 200 can be pushed to the position depicted in FIG. 9 in order to maximize the spring tension force of the spring rod 128 in the direction indicated at 141 in FIG. 9.

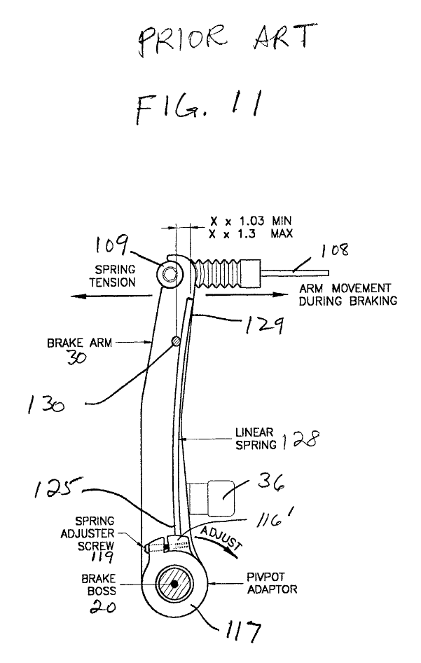

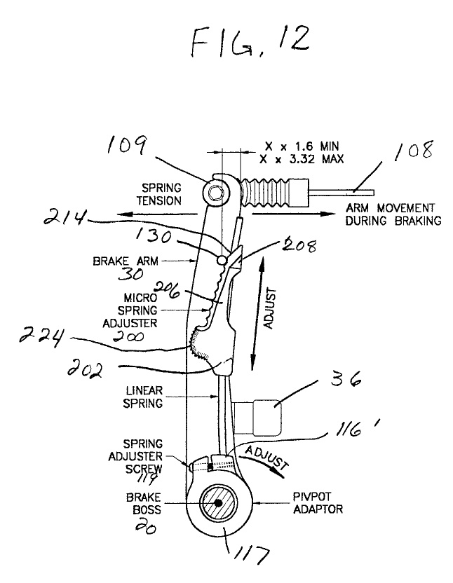

One of the great advantages of the adjuster of the invention is its versatility. It can be utilized with virtually any bicycle brake assembly that employs linear spring rods to bias bicycle brake pads away from the bicycle wheel, since most such bicycle brake assemblies that are commercially available employ linear spring rods having the same diameter. As a consequence, the same adapter can be utilized not only on the cantilevered type brake assembly 10 illustrated in FIGS. 1 through 4, but also on other brake assemblies having different designs, as illustrated in FIG. 12. The same adjuster 200 can also be utilized on the bicycle brake assembly 101 illustrated in FIGS. 20, 21, and 22.

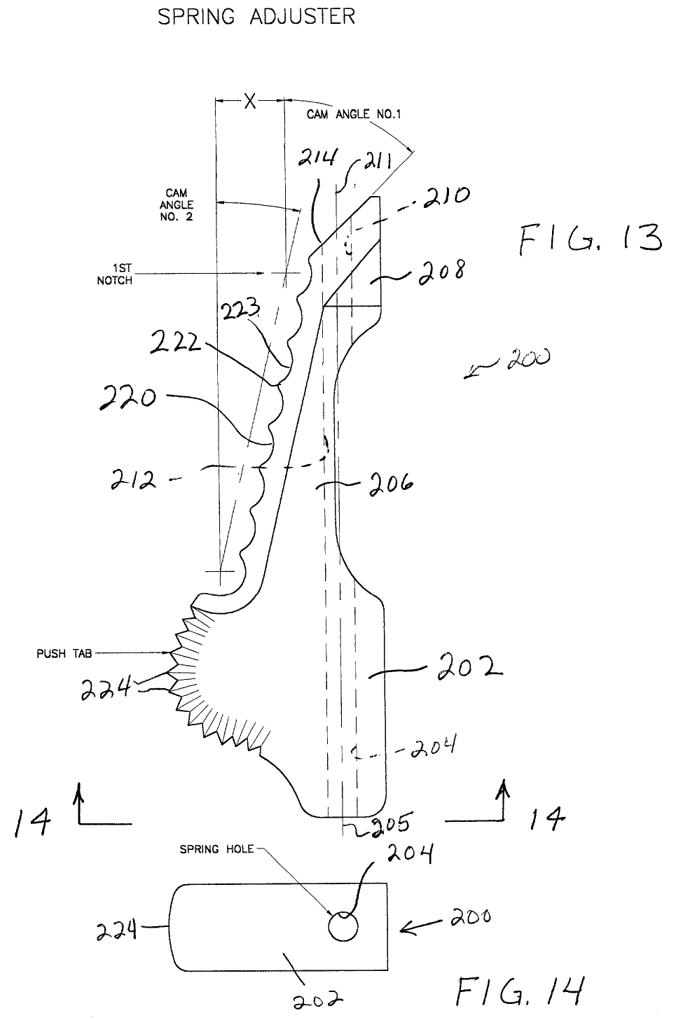

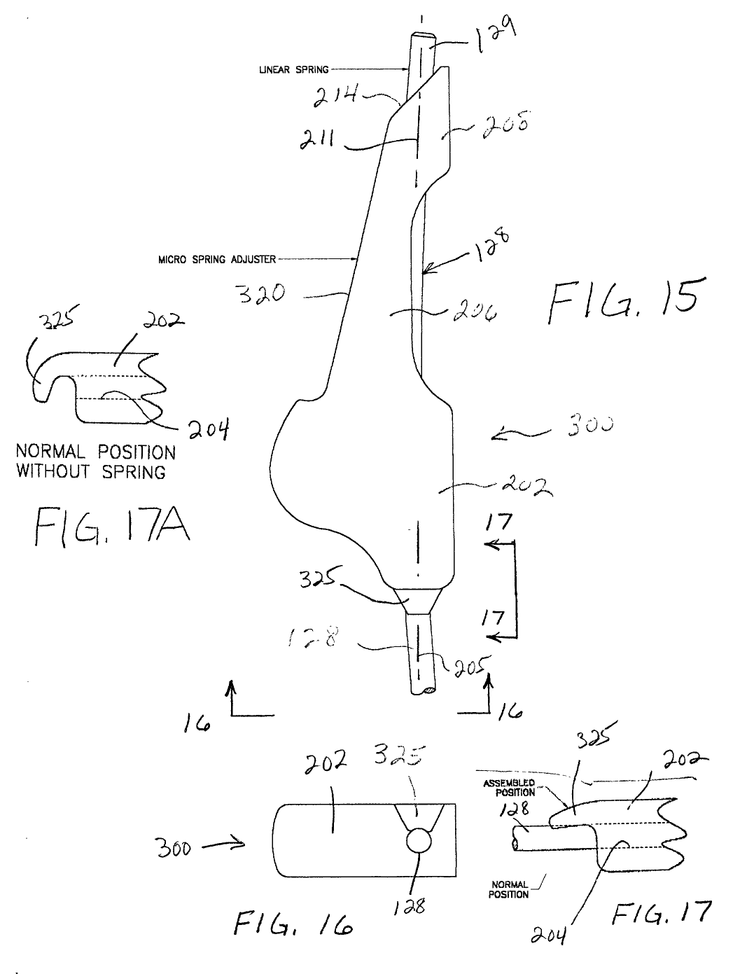

FIGS. 15, 16, 17, and 17A illustrate an alternative embodiment of a micro-spring brake adjuster 300. The spring adjuster 300 also has a body 202, a bridging portion 206 and a foot 208. The brake spring adjuster 300 differs from the brake spring adjuster 200 in that it provides an infinitely variable degree of adjustment, rather than the incremental adjustment provided by the detents 224 illustrated in FIG. 13. In the adjuster 300 the cam surface 320 at the bridging portion 206 is also flat like the surface 214. As a consequence, a bicycle rider can move the adjuster 300 to any position along the length of the linear spring rod 128.

The adjuster 300 also differs from the adjuster 200 in that it includes a curved finger 325 projecting longitudinally from the body 202 toward the proximal, anchored end of the spring rod 128. When the adjuster 300 is detached from the linear spring rod 128, the finger 325 occupies a position at least partially blocking the bore 204 through the body 202 of the adjuster 300 unless resiliently deflected therefrom, as illustrated in FIG. 17A. However, in order to mount the adjuster 300 on the linear spring round 128, the finger 325 must be deflected out of the way to allow passage of the linear spring rod 128 through the cylindrical bore 204 in the body 202, as illustrated in FIG. 17. This resilient deflection of the finger 325 provides a lateral pressure against the spring rod 128 that aids in longitudinally immobilizing the adjuster 300 at any desired position along the length of the linear spring rod 128.

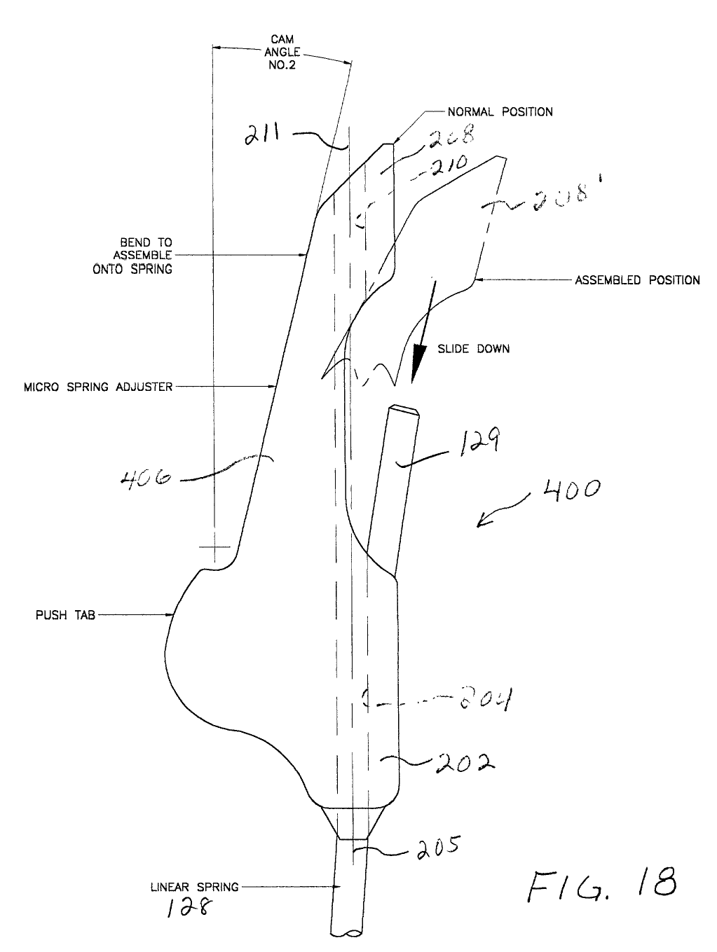

FIG. 18 illustrates a further embodiment of the invention and depicts a bicycle brake spring adjuster 400 that has many of the characteristics and features of the brake spring adjuster 300, illustrated in FIG. 15. However, unlike the brake spring adjuster 300, the bridge portion 406 of the brake spring adjuster 400 is constructed so that a pair of longitudinal bores 204 and 210 through the body 202 and through the foot portion 208, respectively, are fabricated so that the proximal and distal end longitudinal axes of spring rod alignment 205 and 211, respectively, do not reside in mutually coaxial alignment when the bridging portion 206 resides in an undeflected condition, as in the adjusters 200 and 300. Rather, the bores or openings 204 and 210 are created so that the axes 205 and 211 reside at a slight angle of axial misalignment during the fabrication process, as long as the bridge portion 406 remains undeflected. The bridge portion 406 of the adjuster 400 must be resiliently flexed so that the foot 208 moves to the phantom position shown at 208′ in order to insert the free end 129 of the linear spring rod 128 through the openings 204 and 210 of the adjuster 400. As a consequence, the structure of the adjuster 400 exerts a certain amount of lateral tension on the portion of the linear spring rod 128 located between the body 202 and the foot 208. This enhances frictional engagement between the adjuster 400 in the linear spring rod 128, and thereby prevents undesired longitudinal movement of the adjuster 400 along the length of the spring 128.

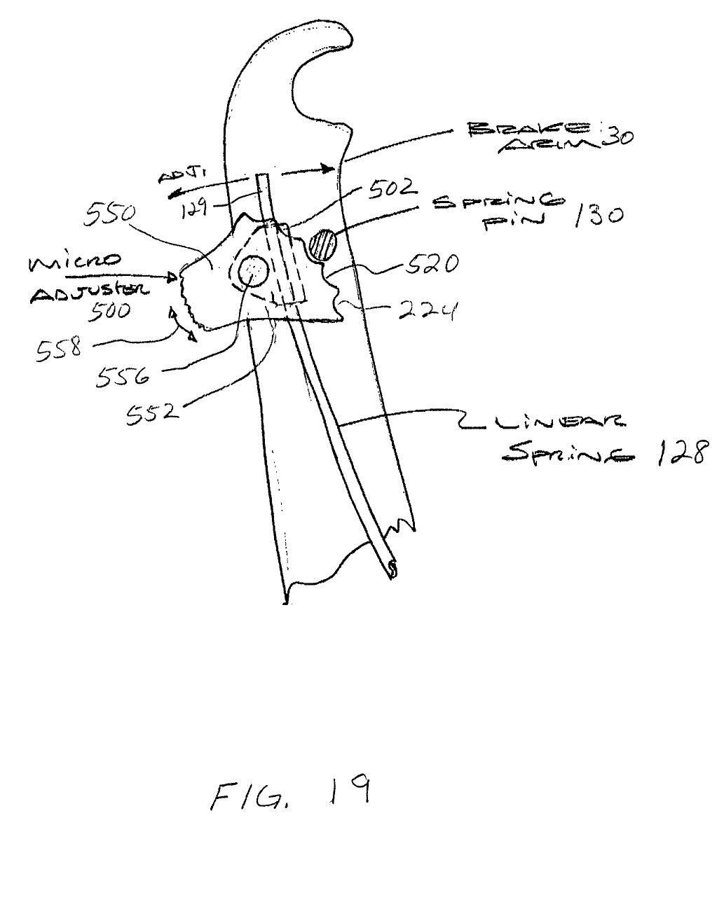

FIG. 19 illustrates still another embodiment of the adjuster according to the invention. The brake spring adjuster 500 depicted in FIG. 19 employs a very short body 502 having a longitudinal bore defined therethrough to receive the linear spring 128. The brake spring adjuster 500 also includes a rotatable cam portion 550 that has a cavity defined therein that accommodates the body 502. The cam portion 550 defines a pair of cheeks 552 on the opposite sides of the body 502. The cheeks 552 are connected together by a web at a cam surface 520 having detents 224 defined therein, as in the adjuster 200. The cam portion 550 is rotatably mounted relative to the body 502 by means of a plastic axle 556 that passes through the cheeks 552 and through the structure of the body 502. There is enough friction between the openings defined through the cheeks 552 of the cam portion 550 so that when the cam portion 550 is rotated by the application of a rotational force indicated by the directional arrows 558, the cam portion 550 will remain at a selected position in rotational alignment relative to the body 502.

As illustrated in FIG. 19, clockwise rotation of the cam portion 550 of the micro-adjuster 500 relative to the body 502 will reduce the tension on the linear spring 128. Counterclockwise rotation of the cam portion 550 relative to the body 502 increases the width of the portion of the structure interposed between the spring pin 130 and the linear spring rod 128. This increases the resilient deflection of the spring rod 128, which increases the biasing force exerted by the spring rod 128 on the spring pin 130 tending to force the brake pad 36 away from the bicycle tire 15.

The micro-spring adjuster of the invention is capable of use on a wide variety of bicycle brake styles that incorporate various types of spring tension systems. The micro-spring adjuster can be mounted and used on different styles of bicycle brakes employing linear spring rods without any tools and without changing the spring tension settings provided by the structures of the brakes as manufactured. A rider can quickly and easily mount the adjuster on the brake assembly and adjust the spring tension without ever dismounting from the bicycle. The rider can increase the gross spring tension of the brake and balance the brake spring tension independently on both sides of the brake. This improves both the function and modulation of the brake. The micro-spring adjuster of the invention can be engaged and disengaged at any time the rider chooses without removing it from the brake. It can be manufactured from plastic, aluminum, steel, wood, or any other type of solid material. The device is very simple to manufacture, assemble, and use, and is therefore a very cost-effective product.

Undoubtedly, numerous variations and modifications of the invention will become readily apparent to those familiar with bicycle brake systems. Accordingly, the scope of the invention should not be construed as limited to the specific embodiment depicted and described.

I claim:

1. A bicycle brake spring tension adjuster for a linear wire bicycle brake spring rod comprising a unitary device shorter in length than said spring rod and having opposing proximal and distal ends and a bridging portion extending therebetween, wherein a proximal end opening is defined in said proximal end thereof for receiving said wire spring rod therewithin in frictional engagement therewith, a distal end opening is defined in the said distal end thereof also for receiving said wire spring rod therewithin in frictional engagement therewith, and at least one cam surface is defined thereon between said proximal and distal ends thereof.

2. A bicycle brake spring tension adjuster according to claim 1 wherein said distal end opening defines a longitudinal axis of alignment and said at least one cam surface is aligned at an angle of between about five degrees and about sixty degrees relative to said longitudinal axis of alignment.

3. A bicycle brake spring tension adjuster according to claim 1 wherein said distal end opening defines a longitudinal axis of alignment and further comprising at least first and second cam surfaces as aforesaid, and said first cam surface is defined on said distal end of said device and said second cam surface is defined on said bridging portion of said device, and said first cam surface is inclined at a greater angle relative to said longitudinal axis than said second cam surface.

4. A bicycle brake spring tension adjuster according to claim 3 wherein said first cam surface is inclined at an angle of between about thirty degrees and about sixty degrees relative to said longitudinal axis.

5. A bicycle brake spring tension adjuster according to claim 3 further characterized in that said second cam surface is inclined at an angle of between about five degrees and about twenty degrees relative to said longitudinal axis.

6. A spring break adjuster according to claim 3 wherein said first cam surface has a linear inclination relative to said longitudinal axis of alignment and said second cam surface defines a plurality of detent recesses thereon adapted to receive a spring rod engaging pin of a bicycle brake.

7. A bicycle brake spring tension adjuster according to claim 3 wherein both of said cam surfaces have linear inclinations relative to said longitudinal axis of alignment and said inclination of said first cam surface is steeper than said inclination of said second cam surface.

8. A bicycle brake spring tension adjuster according to claim 1 wherein at least one outwardly projecting protrusion is defined on said proximal end of said device to facilitate engagement of said device by a user's fingertips for longitudinal movement of said device along said the bicycle brake spring rod.

9. A bicycle brake spring tension adjuster according to claim 1 wherein said bridging portion is resiliently deflectable and said distal end opening defines a distal end longitudinal axis of spring rod alignment at said distal end and said proximal end opening defines a proximal end longitudinal axis of alignment at said proximal end and said device is fabricated so that said distal end longitudinal axis of spring rod alignment and said proximal end longitudinal axis of spring rod alignment are angularly offset from each other when said bridging portion resides in an undeflected condition.

10. A bicycle brake spring tension adjuster according to claim 1 wherein said bridging portion is resiliently deflectable and said distal end opening defines a distal end longitudinal axis of spring rod alignment at said distal end and said proximal end opening defines a proximal end longitudinal axis of alignment at said proximal end and said device is fabricated so that said distal end longitudinal axis of spring rod alignment and said proximal end longitudinal axis of spring rod alignment are coaxially aligned relative to each other when said bridging portion resides in an undeflected condition.

11. A spring brake adjuster according to claim 10 further comprising a resilient finger at said distal end of said unitary device, and said finger at least partially blocks said distal end opening unless resiliently deflected therefrom.

12. A spring tension adjustment device for a linear wire bicycle brake spring rod having an anchored end and an opposite distal end comprising a structure shorter than said spring rod and including:
a body formed with an opening therethrough for receiving said wire spring rod therewithin,
a bridging portion extending from said body in the direction of said distal end of said wire spring rod,
a foot at an end of said bridging portion opposite said body having an opening therethrough defined about a longitudinal axis for receiving said wire spring therewithin, and
at least one cam surface defined on said structure at an inclination relative to said longitudinal axis of said opening in said foot whereby the transverse distance between locations on said at least one cam surface and said longitudinal axis of said opening in said foot varies with longitudinal distance from said distal end of said wire spring rod.

13. A spring tension adjustment device according to claim 12 wherein said structure is fabricated so that said transverse distance between locations on said at least one cam surface increases with longitudinal distance from said distal end of said wire spring rod.

14. A spring tension adjustment device according to claim 13 further comprising a pair of cam surfaces as aforesaid, including a first cam surface on said foot and a second cam surface on said bridging portion and said first cam surface has a greater inclination relative to said longitudinal axis of said opening in said foot than does said second cam surface.

15. A spring tension adjustment device according to claim 14 wherein both of said cam surfaces are linearly inclined relative to said longitudinal axis of said opening in said foot.

16. A spring tension adjustment device according to claim 14 wherein said first cam surface has a linear inclination relative to said longitudinal axis of alignment of said opening in said foot and said second cam surface includes a plurality of ridges between which a plurality of detent recesses are defined and said detent recesses each have a curved shape to conform to the shape of a spring rod engaging pin of a bicycle brake.

17. In a bicycle brake employing a spring rod engaging pin, a stiff, resilient, linear bicycle brake spring rod having an anchored end and an opposite distal end, and wherein said spring rod is resiliently deflected so that said distal end thereof engages said spring rod engaging pin, the improvement comprising a spring tension adjuster having at least one opening defined therethrough to receive said spring rod therewithin and having a cam portion that defines at least one cam surface thereon, and said cam portion is movable to a selected extent into interposition between said spring rod engaging pin and said distal end of said spring rod to thereby vary preload tension on said spring rod.

18. A bicycle brake according to claim 17 wherein said cam surface is flat and said cam portion provides an infinitely variable adjustment of preload tension.

19. A bicycle brake according to claim 13 wherein said cam surface is formed with a plurality of detent recesses, whereby said cam portion varies adjustment of said preload tension in discrete increments.

20. A bicycle brake according to claim 17 wherein said spring tension adjuster is a unitary structure and is engaged on said spring rod by friction and is longitudinally adjustable along said spring rod by manually applied longitudinal pressure, whereby a selected thickness of said cam portion is interposed between said spring rod engaging pin and said spring rod.
